(19) United States
(12) Patent Application Publication
(10) Pub. No.: US 2003/0177298 A1
(43) Pub. Date: Sep. 18, 2003

(54) Dynamic executable code and data image address extension

(76) Inventor: Dan Kaiser, Windom, NH (US)

Correspondence Address: Robert S. Lipton, Esquire, LIPTON, WEINBERGER & HUSICK, 201 North Jackson Street, P.O. Box 934, Media, PA, 19063-0934, US

(21) Appl. No.: 10/071,607

(22) Filed: Feb. 8, 2002

(51) Int. Cl. G06F 12/06

(52) U.S. Cl. 711/2; 717/135; 711/200

(57) ABSTRACT

The method of the present invention comprises splitting pointer data in a code and data image, and allocating the upper half of each pointer in a compressed block to allow a system to exceed a memory addressing limitation during execution, while retaining the same data structure layout. In addition, the method of the present invention compresses and then allocates the upper pointer data “on demand” so that memory requirements during a large pointer (for instance, 64-bit) build are merely incremental over normal pointer (32-bit) requirements.

### BACKGROUND OF THE INVENTION

The present invention pertains to the storage and loading of executable code and data image files for general and special purpose digital computer systems, and to reductions in the storage requirements (for all types of memory including, but not limited to mass storage, read-only memory, and random-access memory) associated with such code and data image files. In the prior art, development systems for computer programs, whether high level such as compilers and linking loaders, or lower level such as assemblers, have always generated executable code and data images intended to be loaded into memory starting at a base address, and proceeding word-for-word (that is, with a bit-for-bit correspondence between the image being loaded and the memory into which it is loaded.) Even when dynamic loaders have been used, the image has been addressed in the image using the same addressing range as in memory. For instance, code and data images which are intended for use in the memory space of a sixteen-bit processor system have been generated and stored in a sixteen-bit address space.

In systems having limited physical memory (for instance in systems having a sixteen-bit address bus but containing less than 65,536 words of physical memory,) segmentation schemes have been used to reduce the demand for memory during execution of the code. In such schemes, the code and data image is typically segmented into modules, called “overlays” that are dynamically loaded and disposed of under control of a memory management system. In early microprocessor-based computers, this memory management system was part of the application code, and resided in the base part of the code and data image (that which was loaded into execution memory and remained there throughout program execution). In more modem systems, memory management has become a function of the operating system, which may use virtual memory schemes to execute code and data images which exceed the size of physical memory, or which exceed the size of some defined segment of physical memory. In such schemes, however, the code and data image size is still determined by the addressing space of the system for which the code and data image is destined.

An analogous problem is that faced by database system administrators when the database approaches and then exceeds the available storage on a disk. In such instances, even a small increment of data requires the addition of a large amount of additional storage. Solutions to this problem have focused on “striping” of the data (intentionally fragmenting it across multiple disks) such as in RAID (redundant array of inexpensive disk) systems in order to provide improved storage efficiency.

Data compression techniques have long been used to compress executable code and data images stored on disk. Several common measures of compression are well known: redundancy [Shannon, C. E., and Weaver, W. 1949. The Mathematical Theory of Communication. University of Illinois Press, Urbana, Ill.], average message length [Huffman, D. A. 1952. A Method for the Construction of Minimum-Redundancy Codes. Proc. IRE 40, 9 (September), 1098-1101.], and compression ratio [Rubin, F. 1976. Experiments in Text File Compression. Commun. ACM 19, 11 (November), 617-623; Ruth, S. S., and Kreutzer, P. J. 1972. Data Compression for Large Business Files. Datamation 18, 9 (September), 62-66.]

When data are compressed, the goal is to reduce redundancy, leaving only the informational content. The measure of information of a source message x (in bits) is −1 g p(x) [where 1 g denotes the base 2 logarithm]. This definition has intuitive appeal; in the case that p(x)=1, it is clear that x is not at all informative since it had to occur. Similarly, the smaller the value of p(x), the more unlikely x is to appear, hence the larger its information content. [Abramson, N. 1963. Information Theory and Coding. McGraw-Hill, New York.]

### BRIEF DESCRIPTION OF THE INVENTION

The method of the present invention comprises splitting pointer data in a code and data image, and allocating the upper half of each pointer in a compressed block to allow a system to exceed a memory addressing limitation during execution, while retaining the same data structure layout. Thus, a 32-bit image may be constructed, even though during execution, the amount of memory required exceeds limits imposed by the pointer size of the system.

In addition, the method of the present invention compresses and then allocates the upper pointer data “on demand” so that memory requirements during a large pointer (for instance, 64-bit) build are incremental over normal pointer (32-bit) requirements.

### DETAILED DESCRIPTION OF THE INVENTION

The first use of the method of the present invention is to mitigate the “memory hump” and incrementally increase capacity during simulation system elaboration processes. The method resolves two longstanding problems:

First, in a simulator system, elaboration requires more memory than simulation to hold temporary data structures that drive the elaboration. This creates a “memory hump” because such systems typically require both temporary elaboration data structures and the simulation memory to be present at once. This causes the memory use during elaboration to be typically larger than the memory use during simulation. In typical systems, elaboration tends to take about twice as much memory as simulation. Furthermore, this means that a 32-bit simulation which requires 2 GB of memory will require 4 GB of memory to elaborate, pushing it close to the limit of a 32-bit address space.

Second, there is a compounding problem in that the jump beyond 4 GB of memory can require twice as much memory in a 64-bit representation as in a 32-bit representation. This is because many simulation data structures tend to be 80% or more pointer data. When the size of all pointers doubles, as it does when changing from a 32-bit to a 64-bit representation, that 80% of the data representing pointers will be twice as large, and the code and data image thus expands by 1.8×, or more. Thus, crossing the address limit boundary by even one word results in a dramatic increase in code size, as modern computer systems cannot arbitrarily increase pointer sizes by only a few bits (to, for instance, a 35-bit pointer) because of architectural constraints.

This also implies that a design with a 2 GB 32 bit simulation image will immediately require close to 8 GB of memory to elaborate in 64-bit mode, and the 64-bit simulation image will be 4 GB.

The method of the present invention remedies this problem by allowing a 64-bit elaboration to generate a 32-bit simulation image, and making the memory increase during the 64-bit elaboration incremental over the 32-bit elaboration size.

Splitting the pointer data and allocating the upper half of each pointer in a temporary block allows the method of the present invention to exceed the 4 GB limit during elaboration, while retaining the same data structure layout. Thus, a 32-bit simulation image may be constructed, even though the elaboration process exceeds the memory limits imposed by 32-bit addressing.

In addition, the method allocates the upper pointer data “on demand” so that elaboration memory requirements during a 64-bit build are incremental over 32 bit requirements. This is especially important in the memory ranges just above an address space limit (for example, 4 GB in a 32-bit system), where otherwise the elaboration memory requirements would immediately double, requiring 8 GB with no benefit of additional elaboration capacity.

Because the on-disk data structure layout remains the same for 32-bit simulations, parts of the systems that do not need to handle greater than 4 GB of data at a time, such as the parser, have minimal changes to implement the method of the present invention. This also includes the simulator and runtime libraries, as long as simulation is limited to 4 GB simulations. Beyond 4GB simulations, the split 64-bit addressing of the present invention may be employed, but support for accessing 64-bit pointers must be implemented in the code generator and it is expected that there may be some performance degradation due to this.

### EXAMPLES

Part 1—Simulation Data Structures.

The following examples are related to the NC-Verilog simulation system, available from Cadence Design Systems, Inc. of San Jose, Calif., U.S.A.

System pointer type.

The method of the present invention defines a “system pointer type” in sconfig/sconf.h which is:

| | |
|---|---|
| typedef int32_t | if_ptr32_t; |

This will be used on all the pointer definitions in the simulation data structures. “long *”, “char *”, etc. will all be replaced with this type definition in the “if managed files”: ast.h, vst.h, cod.h, rts.h and sss.h.

For instance, in sss.h, the data structure drp_s is changed from:

struct drp_s {

long *drp_method;
drp_t *drp_next;

}

to

typedef if_ptr32_t drp_t_p;
struct drp_s {

if_ptr32_t drp_method;
drp_t_p drp_next;

}

Simulation data structures are then modified so that the 64-bit representation is the split into upper and lower 32-bit “slices”. A contiguous segment of memory is represented in the system by a if context_block_s structure. A pointer to the upper 32 bit slice is added into this structure so that to allow allocation and referencing the upper slice on demand.

In ifmgr.h, an additional field (ifcg_upper is added to if context_block_s. In 32-bit mode, this field will always be NULL. However, context_block_s must have the same format in both 32 and 64 bit modes, since this structure will be used in both modes and the other fields must align correctly. So a new type, which is 64 bits wide is defined in both modes and used to define the new field.

typedef int64_t if_ptr64_t;
struct if_context_block_s {

. . .
if_ptr64_t ifcb_upper;

}

Initially, ifcb_upper will be NULL, and in 32-bit mode this field will always be NULL. In a 64-bit elaboration, this field will be filled in by the access routine (if write-ptr), if any pointer has upper bits, which are non-NULL. This memory is allocated out of non-context data and is not saved to disk so that it does not become part of the simulation snapshot.

Part 2—Access Routines (ifmgr.c).

New read and write (if read_ptr and if_write_ptr) routines are implemented for handling access to the new pointer representation. Access to non-pointer data does not change and the code which deals with this data does not change.

| | |
|---|---|
| #ifdefLP64BUILD | |
| #define IFR_UPPER_PTR(ptr) | ((if_ptr32_t)(((if_ptr64_t)ptr)>>32)) |
| #define IFR_LOWER_PTR(ptr) | ((if_ptr32_t)((if_ptr64_t)(ptr) & 0xffffffff)) |
| #else | |
| #define IFR_UPPER_PTR(ptr) | (NULL) |
| #define IFR_LOWER_PTR(ptr) | ((if_ptr32_t)(ptr)) |
| #endif | |

void
if_allocate_upper(if_context_block_t *cp)
{

cp−>ifcb_upper = (if_ptr64_t) salloc (cp−>ifcb_size);;

}
if_ptr32_t
if_find_upper(if_ptr_t loc)
{
#ifdefLP64BUILD

if_context_block_t **cp;
cp = if_ldd_xfind(loc, IF_LDD_NORMAL);
if((*cp)−>ifcb_upper) {

return(if_ptr32_t)(((char*)(*cp)−>ifcb_upper)[loc-(if_ptr_t)(*cp)-

>ifcb_root]);

}

#endif

return NULL;

}
if_ptr_t
if_read_ptr (if_ptr_t loc)
{
#ifdefLP64BUILD

if_context_block_t **cp;
cp = if_ldd_xfind (loc, IF_LDD_NORMAL);
if((*cp)−>ifcb_upper) {

return (if_ptr_t)(((if_ptr64_t)if_find_upper(loc)<<32)|*(if_ptr32_t*)loc);

}

#endif

return (if_ptr_t) *(if_ptr32_t *)loc;

}
void
if_write_ptr (if_ptr_t ptr, if_ptr_t loc)
{
#ifdefLP64BUILD

if_context_block_t **cp;
if (IFR_UPPER_PTR(ptr)) {

cp = if_ldd_xfind (loc, IF_LDD_NORMAL);
if (!(*cp)−>ifcb_upper) {

if_allocate_upper(*cp);

}
(((char*)(*cp)−>ifcb_upper)[loc-(if_ptr_t)(*cp)−>ifcb_root]) =

IFR_UPPER_PTR(ptr);

*(if_ptr32_t *)loc = IFR_LOWER_PTR(ptr);
return;

}

#endif

*(if_ptr32_t *)loc = IFR_LOWER_PTR(ptr);

}

Part 3—Use of The Access Routines.

All references to pointer fields in snapshot data structures must be changed to use the new pointer access routines of the present invention. (This code is mostly in libs/curly and libs/rtslib of the NC-Verilog system.)

As an example of the changes required, as conditional access to the upper slice is added, take the references to drp_s.drp_next in the routine gate_fanin in gate.c:

if (tgs−>sgs.drp.drp_next)

becomes

if (if_read_ptr((if_ptr_t) &tgs−>sgs.drp.drp_next))

and

tgs−>sgs.drp.drp_next = (drp_t *) &xtgs−>sgs;

becomes

if_write_ptr ((if_ptr_t) &tgs−>sgs.drp.drp_next, (if_ptr_t)
&xtgs−>sgs);

Example program showing record “slicing” and compression.

#_{——————————————}
#include <stdio.h>
#include <macros.h>
/*

Begin with a set of records that contain mixed data and pointers. The “natural” expression for this has each element in the record structured in contiguous memory locations. For example, a C record is structured in this way. In this example, a C char type is used for data, and a char* for pointers.

struct record_s {

char data1;
char *pointer2;
char data3;
char *pointer4;

};

In phase 1, build a database of records containing mixed pointers and data, which conceptually looks like the C record shown above. However, according to the present invention, the records are structured in “stripes” in memory, where each can be varying width, and there are enough stripes to hold the widest possible element.

At the end of phase 1, the contents of the address elements in each stripe are examined. If all the address elements have zeros in that stripe, and there are no data elements in the stripe, that stripe will be deleted. The number of stripes is then changed to indicate which set of stripes contain non-zero data and pointers.

For clarity in this example, each stripe is 1-byte wide. It is necessary to allocate enough stripes to hold the widest data type.

Again, for clarity, this example will allow and compress a single record, but the method of the present invention functions identically for multiple records.

Example built and run on Sparc (system from Sun Microsystems of Mountain View, Calif., U.S.A.):

cc -g -xs -xarch=v9 -M /usr/lib/ld/sparcv9/map.below4G test.c
a.out

Example Output:

data size = 1
pointer size = 8
data1 = 5
&record−>data1 = 80102114
data3 = 66
&record−>data3 = 80102116
nstripes = 4
*pointer2 −> data1 = 5
*pointer4 −> data3 = 66

*/
struct stripe_s {

unsigned char data1;
unsigned char pointer2;
unsigned char data3;
unsigned char pointer4;

};
typedef struct stripe_s stripe_t;
#define DATA_SIZE (sizeof(char))
#define NSTRIPES (max(sizeof(char),sizeof(char*))/DATA_SIZE)
typedef stripe_t record_t[NSTRIPES];
/*

The records will not be represented in a standard C format, so access functions to store and retrieve the data are required. (A load and store function for each data type element handled.) For the sake of clarity, separate access functions for each field in the record are defined.

(One actually need only know the offset of each field to create generic access functions.)

It is not shown here, but that may be done underneath the separate field access functions.

*/
void
store_data1 (record, stripes, element, element_size)

| | |
|---|---|
| record_t record; | /* record to store the element into */ |
| int stripes; | /* number of stripes */ |
| char element; | /* pointer to save */ |
| int element_size; | /* size of the element */ |

{

record[0].data1 = element;

}
void
load_data1 (record, stripes, element_ptr, element_size)

| | |
|---|---|
| record_t record; | /* record to load the element from */ |
| int stripes; | /* number of stripes */ |
| char *element_ptr; | /* pointer to the element */ |
| int element_size; | /* size of the element */ |

{

*element_ptr = record[0].data1;

}
void
store_pointer2 (record, stripes, element_ptr, element_size)

| | |
|---|---|
| record_t record; | /* record to store the element into */ |
| int stripes; | /* number of stripes */ |
| char *element_ptr; | /* pointer to save */ |
| int element_size; | /* size of the element */ |

{

int i;
unsigned long ptr = (unsigned long) element_ptr;
for (i=0; i<element_size; i++) {

record[i].pointer2 = ptr & 0xff;
ptr >>= 8;

}

}
void
load_pointer2 (record, stripes, element_ptr, element_size)

| | |
|---|---|
| record_t record; | /* record to load the element from */ |
| int stripes; | /* number of stripes */ |
| char **element_ptr; | /* pointer to the pointer element */ |
| int element_size; | /* size of the element */ |

{

int i;
unsigned long ptr = 0;
for (i=min(stripes,element_size)−1; i>=0; i--) {

ptr = (ptr << 8) | record[i].pointer2;

}
*element_ptr = (char *) ptr;

}
void
store_data3 (record, stripes, element, element_size)

| | |
|---|---|
| record_t record; | /* record to store the element into */ |
| int stripes; | /* number of stripes */ |
| char element; | /* pointer to save */ |
| int element_size; | /* size of the element */ |

{

record[0].data3 = element;

}
void
load_data3 (record, stripes, element_ptr, element_size)

| | |
|---|---|
| record_t record; | /* record to load the element from */ |
| int stripes; | /* number of stripes */ |
| char *element_ptr; | /* pointer to the element */ |
| int element_size; | /* size of the element */ |

{

*element_ptr = record[0].data3;

}
void
store_pointer4 (record, stripes, element_ptr, element_size)

| | |
|---|---|
| record_t record; | /* record to store the element into */ |
| int stripes; | /* number of stripes */ |
| char *element_ptr; | /* pointer to save */ |
| int element_size; | /* size of the element */ |

{

int i;
unsigned long ptr = (unsigned long) element_ptr;
for (i=0; i<element_size; i++){

record[i].pointer4 = ptr & 0xff;
ptr>>= 8;

}

}
void
load_pointer4 (record, stripes, element_ptr, element_size)

| | |
|---|---|
| record_t record; | /* record to load the element from */ |
| int stripes; | /* number of stripes */ |
| char **element_ptr; | /* pointer to the pointer element */ |
| int element_size; | /* size of the element */ |

{

int i;
unsigned long ptr = 0;
for (i=min(stripes,element_size)−1; i>=0; i--) {

ptr = (ptr << 8) | record[i].pointer4;

}
*element_ptr = (char *) ptr;

}
/*
* Compress_record - Find and eliminate the stripes that contain

| | |
|---|---|
| * | all zero contents. Return the width of the subrecord which |
| * | contains the last non-zero stripe. This will be the width |
| * | of the new compressed record. |

*/
int
compress_record (record)

| | |
|---|---|
| record_t record; | /* record to compress */ |

{

int i;
int nstripes = 0;
for (i=0, nstripes=0; i<NSTRIPES; i++) {

if (record[i]. data1 ∥ record[i].pointer2
∥ record[i].data3 ∥ record[i].pointer4) {

nstripes = i+1;

}

}
return nstripes;

}
void
init ( record)

| | |
|---|---|
| record_t record; | /* record to compress */ |

{

int i;
for (i=0; i<NSTRIPES; i++) {

record[i].data1 = 0;
record[i].pointer2 = 0;
record[i].data3 = 0;
record[i].pointer4 = 0;

}

}

| | |
|---|---|
| record_t record; | /* record to build and compress */ |

void
main ( )
{

| | |
|---|---|
| char data_element; | /* data element */ |
| char *data_pointer; | /* pointer element */ |
| int nstripes; | /* number of stripes in record */ |

```
printf (“data size = %d\n”, sizeof(data_element));
printf (“pointer size = %d\n”, sizeof(data_pointer));
/*
  * Initialize the record.
*/
init (record);
/*
* Phase 1 - build the record.
*/
printf(“data1 = %d\n”, 5);
store_data1 (record, NSTRIPES, (char) 5, sizeof(data_element));
printf (“&record−>data1 = %1x\n”, &record−>data1);
store_pointer2 (record, NSTRIPES, &record−>data1,
sizeof(&record−>data1));
printf(“data3 = %d\n”, 66);
store_data3 (record, NSTRIPES, (char) 66, sizeof(data_element));
printf (“&record−>data3 = %1x\n”,
&record−>data3);
store_pointer4 (record, NSTRIPES, &record−>data3,
sizeof(&record−>data3));
/*
  * End of Phase 1 - compress the record.
  */
nstripes = compress_record (record);
printf (“nstripes = %d\n”, nstripes);
/*
  * Phase 2 - access data fields in the compressed record.
  */
load_pointer2 (record, nstripes, &data_pointer,
sizeof(data_pointer));
printf (“*pointer2 −> data1 = %d\n”, *data_pointer);
load_pointer4 (record, nstripes, &data_pointer,
sizeof(data_pointer));
printf (“*pointer4 −> data3 = %d\n”, *data_pointer);
```

}

While the invention has been described in its preferred embodiments, it is to be understood that the words which have been used are words of description rather than of limitation and that changes may be made within the purview of the appended claims without departing from the true scope and spirit of the invention in its broader aspects. The inventors further require that the scope accorded their claims be in accordance with the broadest possible construction available under the law as it exists on the date of filing hereof, and that no narrowing of the scope of the appended claims be allowed due to subsequent changes in the law, as such a narrowing would constitute an ex post facto law, and a taking without due process or just compensation.

I claim:

1. A method for reducing the memory requirement of an executable code and data image comprised of a plurality of records, comprising:
a. Segmenting each record into a plurality of stripes, each of such stripes being a predetermined number of bits in width;
b. Examining each stripe to identify those stripes having homogeneous contents;
c. Deleting all of the stripes identified as having homogeneous all zero contents from memory; and
d. Constructing a code and data image comprised of only the remaining stripes, and having a pointer width smaller than that of the unsegmented record.

2. The method of claim 1 wherein the width of each stripe is the native word size of the target computer processor system on which the code and data image is desired to operate.

3. The method of claim 1 wherein the width of each stripe is 32 bits.

4. A method for reducing the memory requirement of an executable code and data image comprising, at least in part, pointer data, comprising the steps of:
a. Segmenting each pointer into a lower and an upper half;
b. Storing the lower half in memory at a known address;
c. Providing an offset function for determining the address of the upper half using the address of the lower half as a parameter thereof and storing the upper half at the address determined by execution of the offset function; and
d. Accessing the lower half and then accessing the upper half using the offset function to provide access to the entire pointer.

5. The method of claim 4 wherein the offset function is a data compression function.

6. The method of claim 5 wherein the data compression function removes only zero valued upper half pointers.

7. The method of claim 5 wherein the data compression function is selected from the class of redundancy reduction, average message length, or compression ratio algorithms.

8. A method for reducing the memory requirement of an executable code and data image comprised of a plurality of records, comprising:
a. Segmenting each record into a plurality of stripes, each of such stripes being a number of bits in width;
b. Examining each stripe to identify those stripes having homogeneous contents;
c. Deleting all of the stripes identified as having homogeneous contents from memory; and
d. Constructing a code and data image comprised of only the undeleted stripes, and having a pointer width smaller than that of the unsegmented record.
